(19) United States
(12) Patent Application Publication
(10) Pub. No.: US 2007/0013503 A1
(43) Pub. Date: Jan. 18, 2007

(54) Patch-type tire status monitoring apparatus

(75) Inventors: Chao-Heng Chien, Taipei City (TW); Kun-Neng Chang, Taipei City (TW)

Correspondence Address: BACON & THOMAS, PLLC, 625 SLATERS LANE, FOURTH FLOOR, ALEXANDRIA, VA, 22314, US

(73) Assignees: Kuender Co., Ltd., Taipei City (TW); Tatung Company, Taipei City (TW); Lenghways Technology Co., Ltd., Taipei City (TW)

(21) Appl. No.: 11/484,626

(22) Filed: Jul. 12, 2006

(30) Foreign Application Priority Data
Jul. 14, 2005 (TW) 094123880

(51) Int. Cl. B60C 23/00

(52) U.S. Cl. 340/447

(57) ABSTRACT

The present invention relates to a patch-type tire status monitoring apparatus, which comprises a flexible substrate having an adhering side and a signal processing circuit; a tire status monitoring unit that is affixed to the non-adhering side of the flexible substrate; an antenna; and a wireless transmitting unit that is configured to transmit the signals sent by the tire status monitoring unit. The patch-type tire status monitoring apparatus of the present invention can be easily installed by utilizing the flexibility of the substrate to be firmly affixed to a rim. Since the apparatus does not require any exterior cover, the overall weight can be significantly reduced, which ultimately avoids any potential imbalance and misalignment problems on the wheels.

### BACKGROUND OF THE INVENTION

1. Field of the Invention

The present invention relates to a tire status monitoring apparatus and, more particularly, to a patch-type tire status monitoring apparatus.

2. Description of Related Art

Nowadays many traffic accidents, especially those that take place on highways, are attributed to tire-related breakdowns. Most of those breakdowns that can be detected include the air pressure and the temperature of a tire. Tires of any vehicle can perform normally under proper inflation. However, if there is not sufficient pressure within a tire, both the tube and the tire will quickly wear out and become damaged, resulting in imbalances in terms of the loading that the respective tire can carry, which usually will lead to traffic accidents. Under the operation of a vehicle, tires will constantly lose pressure mainly due to the wear and tear or punctures of the tires.

Currently, most tire status monitoring devices can detect the changes in the tire pressure. This type of device is called ‘Tire Pressure Monitoring System’ (TPMS), which is utilized to automatically monitor the pressure and provide instantaneous warning on any irregularity detected in the pressure of the tires for safety measures while the vehicle is on the road. Beginning in 2007, the National Highway Traffic Safety Administration (NHTSA) of the United States will require every car sold to be installed with TPMS as mandatory.

For convenience purpose, the conventional method of installing the aforementioned device generally employs a steel fastener to stabilize the TPMS on the rim or on the valve of the wheel. However, this type of the device tends to be excessively large, such that it is relatively easy for the tires to become damaged due to improper disassembling when replacing them. Besides, because of the aforementioned structure and the weight of the device, an imbalance problem is created which results in abnormal wear and tear to the wheels.

Therefore, it is desirable to come up with a light yet easily installed tire status monitoring device to overcome the above problems.

### SUMMARY OF THE INVENTION

The present invention provides an easily installed patch-type tire status monitoring apparatus. With the unique flexible substrate, the apparatus can be perfectly affixed onto the surface of a rim, such that the damage that would otherwise happen to the apparatus when replacing the tire can be minimized. Also, the apparatus does not require any exterior cover, thus the overall weight of the apparatus can be significantly reduced to avoid any imbalance or misalignment problems on the wheels. Furthermore, with the flexible substrate, the apparatus can be firmly attached along the curvature of the rim.

The patch-type tire status monitoring apparatus of the present invention comprises a flexible substrate having an adhering side and a signal processing circuit; a tire status monitoring unit that is affixed to the non-adhering side of the flexible substrate; an antenna; and a wireless transmitting unit that is configured to transmit the signals sent from the tire status monitoring unit.

The flexible substrate is preferably a soft printed circuit board, but the type of the substrate is not limited. Also, the apparatus of the present invention comprises a protective film that is wrapped entirely around the flexible substrate, the tire status monitoring unit, the antenna and the wireless transmitting unit, such that these electronic components do not become damaged or oxidized by any outside forces.

The apparatus of the present invention further comprises a power supply unit, which is configured to supply sufficient power to the built-in units. Also, the present invention further includes a receiver that is configured to receive signals sent from the wireless transmitting unit of the apparatus. The receiver can be located in the interior of a vehicle and particularly installed on the dashboard to relay instantaneous information regarding the status of the tires to the users; however, the location of the receiver is not intended to be so limited.

The adhering side of the flexible substrate of the apparatus preferably contains adhesive or magnetic materials to provide a firm attachment with respect to the contact surface of the rim and to avoid any potential detachment caused by the high-speed rotation of the wheel or any other outside forces; however, the adhering material is not intended to be so limited.

### BRIEF DESCRIPTION OF THE DRAWINGS

FIG. 1 is a schematic block diagram illustrating the structure of the tire status monitoring apparatus of the present invention.

FIG. 2 is a diagram in partial view showing the location where the tire status monitoring apparatus is affixed onto the rim of a wheel according to the present invention.

FIGS. 3(a) and (b) are diagrams respectively in perspective and side views showing the location where the tire status monitoring apparatus is affixed onto the rim of a wheel according to the present invention.

### DETAILED DESCRIPTION OF THE PREFERRED EMBODIMENT

The patch-type tire status monitoring apparatus provided by the present invention comprises a flexible substrate. In a preferred embodiment, a soft printed circuit board 10 is disclosed. The characteristic of a soft printed circuit board is that its shape can be flexibly altered in accordance to the appearance of an object, particularly when it is intended to be attached onto another object, allowing two objects to be firmly affixed to each other such that the attachment can be strengthened.

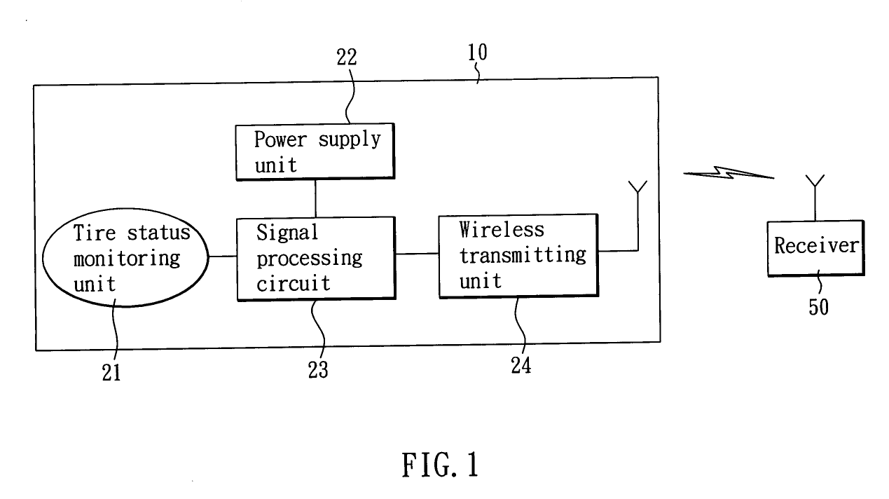

In the preferred embodiment, multiple monitoring units are welded on one side of the soft printed circuit board 10. As shown in FIG. 1, the soft printed circuit board 10 can comprise a tire status monitoring unit 21; a signal processing circuit 23, which can be a microprocessor or a digital signal processor in the preferred embodiment that is configured to process those signals provided by the monitoring units; a power supply unit 22; and a wireless transmitting unit 24, which is used to transmit the processed signals wirelessly to a receiver 50.

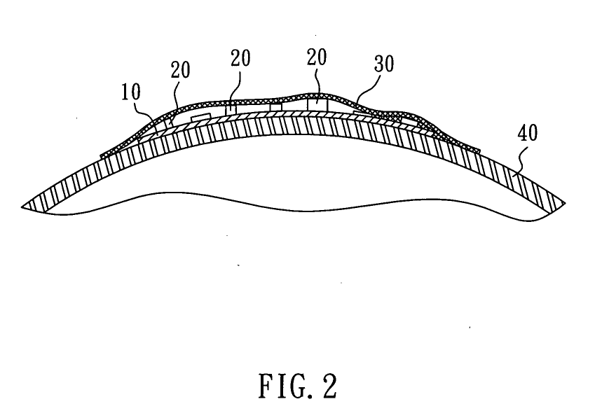

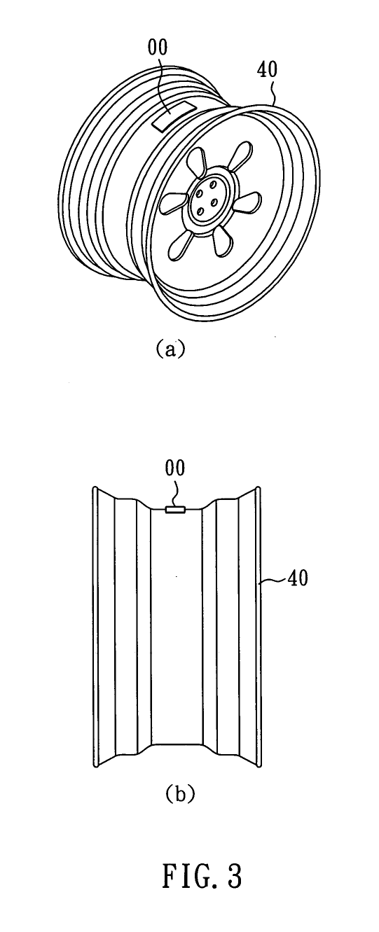

In accordance to FIG. 2, the other side of the soft printed circuit board 10 is coated with adhesive (not shown in the figure), such that it is favorable for affixing the patch-type tire status monitoring apparatus 00 onto a rim 40, preferably in a way that the adhering side of the apparatus 00 can be firmly attached to the rim 40 and tightly alongside the curvature as shown in FIG. 3(a) and FIG. 3(b). The benefit of installing the apparatus at such location is to prevent any outside forces from damaging the apparatus while the vehicle is in motion, such that the life of the apparatus can be prolonged.

After having each respective electronic unit (e.g. the tire status monitoring unit 21, the power supply unit 22, the signal processing circuit 23 and the wireless transmitting unit 240) welded on the apparatus in the preferred embodiment, a layer of protective film 30 is applied to wrap around the apparatus as a means to protectively insulate the apparatus completely from any air or moisture.

Whilst the vehicle installed with the tire status monitoring apparatus is in motion, the tire status monitoring unit 21, in this example the tire pressure monitoring unit, will activate its monitoring component to initiate monitoring the status within the tires. After a predetermined time, the status of the tires determined by the monitoring unit 21 will be sent to the signal processing circuit 23. As the information is being processed, for example, by converting analog signals into digital signals or any other signals that can be read by the receiver 50, the converted signals will later be sent to the wireless transmitting unit 24 and then transmitted wirelessly to the receiver 50 set up remotely from the tires. Finally, the information is replayed via the connection of the receiver 50 to a display device (e.g. a dashboard), such that the driver or the passengers can be fully aware of the current status with regard to the tires.

The receiver 50 incorporated with the patch-type tire status monitoring apparatus can be located in accordance to the actual applications and designs, for example, on the hood, doors, side mirrors or the onboard computers of the vehicle; however, the location of the installation is not intended to be so limited.

The patch-type tire status monitoring apparatus of the present invention can be firmly attached to the surface of the rim to minimize the damage that would otherwise be caused to the apparatus when replacing the tire. Also, since the apparatus does not require any exterior cover; the overall weight of the apparatus can be significantly reduced to avoid any imbalance or misalignment issues of the wheels. Further, since the present invention is designed in a patch configuration, the location for installing the apparatus is not limited, and therefore it possesses potential for a greater utility in practice.

Although the present invention has been explained in relation to its preferred embodiment, it is to be understood that many other possible modifications and variations can be made without departing from the scope of the invention as hereinafter claimed.

What is claimed is:

1. A patch-type tire status monitoring apparatus, comprising:
a flexible substrate having an adhering side and a signal processing circuit;
a tire status monitoring unit affixed to the non-adhering side of said flexible substrate;
an antenna; and
a wireless transmitting unit configured to transmit the signals of said tire status monitoring unit.

2. The apparatus as claimed in claim 1, wherein said flexible substrate is a soft printed circuit board.

3. The apparatus as claimed in claim 1 further comprising a protective film wrapped around said flexible substrate, said tire status monitoring unit, said antenna and said wireless transmitting unit.

4. The apparatus as claimed in claim 1 further comprising a power supply unit.

5. The apparatus as claimed in claim 1 further including a receiver configured to receive signals sent from said wireless transmitting unit.

6. The apparatus as claimed in claim 1, wherein the adhering side of said flexible substrate contains adhesive.

7. The apparatus as claimed in claim 1, wherein the thickness of said apparatus is smaller than the size of the flange of the rim, to which said apparatus is affixed.
